(19) United States
(12) Patent Application Publication
(10) Pub. No.: US 2015/0241014 A1
(43) Pub. Date: Aug. 27, 2015

(54) ILLUMINATION DEVICE

(71) Applicant: Dr. Ing. h.c. F. Porsche Aktiengesellschaft, Stuttgart (DE)

(72) Inventor: Burkhard Leutiger, Pforzheim (DE)

(21) Appl. No.: 14/616,777

(22) Filed: Feb. 9, 2015

(30) Foreign Application Priority Data
Feb. 26, 2014 (DE) 102014102495.8

(51) Int. Cl. F21S 8/10

(52) U.S. Cl. CPC F21S 48/2212; F21S 48/255; F21S 48/218; F21S 48/225; F21W 2101/14

(57) ABSTRACT

An illumination device for a motor vehicle includes a plurality of punctiform light sources configured to illuminate a woven material.

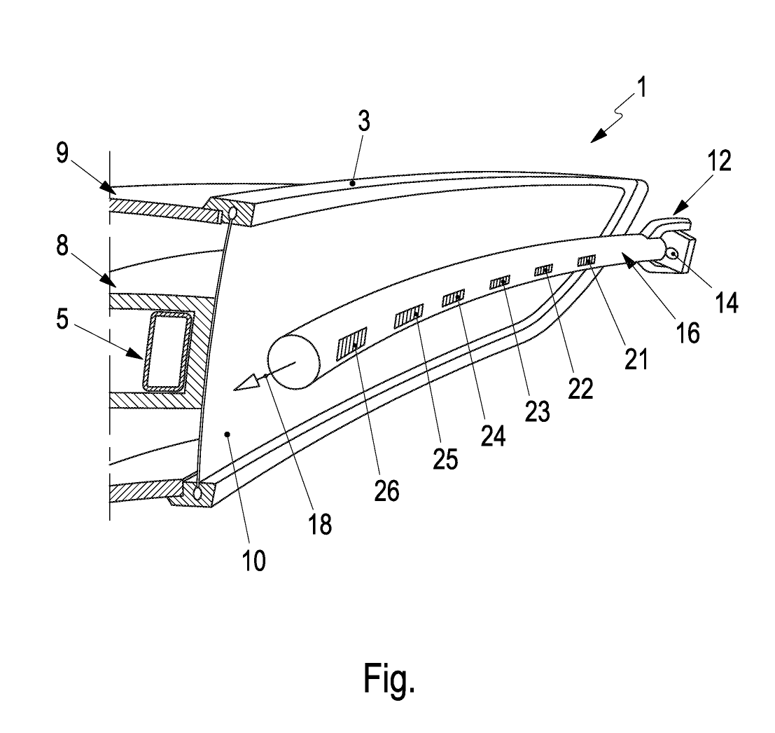

### CROSS REFERENCE TO RELATED APPLICATIONS

Priority is claimed to German Patent Application No. DE 2014 10 102 495.8, filed on Feb. 26, 2014, the entire disclosure of which is hereby incorporated by reference herein.

### FIELD

The invention relates to an illumination device for a motor vehicle, having at least one light source which serves for illuminating a woven material. The invention relates furthermore to a tail lamp having such an illumination device. The invention moreover relates to a motor vehicle having such a tail lamp.

### BACKGROUND

The Korean utility model KR 20-0451523 Y1 discloses a tail lamp having an illuminated textile insert.

### SUMMARY

In an embodiment, the present invention provides an illumination device for a motor vehicle including a plurality of punctiform light sources configured to illuminate a woven material

### BRIEF DESCRIPTION OF THE DRAWINGS

The present invention will be described in even greater detail below based on the exemplary figure. The invention is not limited to the exemplary embodiments. All features described and/or illustrated herein can be used alone or combined in different combinations in embodiments of the invention. The features and advantages of various embodiments of the present invention will become apparent by reading the following detailed description with reference to the attached drawings which illustrate the following:

The single accompanying figure illustrates an illumination device according to the invention in a simplified perspective.

### DETAILED DESCRIPTION

An aspect of the invention is to improve the structure and/or function of illumination devices for motor vehicles having at least one light source serving for illuminating a woven material.

An aspect relating to an illumination device for a motor vehicle, having at least one light source which serves for illuminating a woven material is achieved in that the illumination device comprises a plurality of punctiform light sources serving for illuminating the woven material. By using punctiform light sources, in combination with the woven material, it is possible to simply achieve spot illumination to achieve a depth effect.

One preferred exemplary embodiment of the illumination device is characterized in that the illumination device comprises an optical waveguide for representing the punctiform light sources. The use of the optical waveguide for representing the punctiform light sources, which can also be designated light spots, among others has the advantage that a multiplicity of LEDs, which can also be used as punctiform light sources, can be omitted.

A further preferred exemplary embodiment of the illumination device is characterized in that the optical waveguide for representing the punctiform light sources comprises a prism arrangement. By virtue of the prism arrangement, the woven material can be backlit particularly advantageously.

A further preferred exemplary embodiment of the illumination device is characterized in that the prism arrangement comprises a plurality of spaced-apart prisms. The prisms are arranged advantageously on a rear face of the optical waveguide, such that light is reflected in the direction of a front face in order to make possible spot illumination of the woven material.

A further preferred exemplary embodiment of the illumination device is characterized in that the illumination device is integrated in a lamp of a motor vehicle. Integrated in the lamp of the motor vehicle is advantageously at least one further illumination device. The illumination device according to the invention advantageously serves only for achieving a specific depth effect.

A further preferred exemplary embodiment of the illumination device is characterized in that the punctiform light sources in the lamp are configured and arranged relative to the woven material such that a depth effect is achieved in the lamp. The optical waveguide of the illumination device according to the invention advantageously does not have output optics across its entire rear face. According to one aspect of the invention, the optical waveguide now only has some output optics, in particular in the form of prisms, at desired locations. The width of the output regions and the gaps therebetween can be selected freely. As a result, it is possible in particular to freely configure a parabola effect.

A further preferred exemplary embodiment of the illumination device is characterized in that the woven material has special light-refractive properties. The woven material is particularly suitable for producing optical depth effects in lamps.

The invention also relates to a tail lamp having an illumination device as described above.

One preferred exemplary embodiment of the tail lamp is characterized in that the woven material is spanned inside a frame of the tail lamp. Arranged on a front face of the woven material is, for example, a further illumination device. Arranged on the rear face of the woven material is advantageously the illumination device according to the invention, in particular the optical waveguide.

The invention moreover relates to a motor vehicle having a tail lamp as described above. The tail lamp can be mounted centrally on the motor vehicle. The tail lamp can, however, also be one of two tail lamps which are arranged on the right and on the left at the rear of the motor vehicle.

The invention relates, if appropriate, also to a method for operating an illumination device as described above in a motor vehicle.

Further advantages, features and details of the invention result from the following description, in which the various exemplary embodiments are described in detail with reference to the drawing.

The accompanying figure illustrates a tail lamp 1 of a motor vehicle in a simplified perspective. The tail lamp 1 comprises a frame 3 and an illumination device 5.

The illumination device 5 is indicated merely by a rectangle and is surrounded partially by a bezel 8. The bezel 8 is arranged inside a bezel 9, which is mounted on the frame 3.

Spanned inside the frame 3 of the tail light 1 is a woven material 10. The woven material 10 has specific light-refractive properties. Assigned to the woven material 10 is an illumination device 12 according to the invention so as to achieve an optical depth effect in the tail lamp 1.

The illumination device 12 according to the invention comprises a light source 14 and an optical waveguide 16. The optical waveguide 16 is a tubular optical waveguide, through which the light supplied by the light source 14 is guided in the direction of an arrow 18.

The light source 14 is what is known, for example, as an LED. The letters LED stand for light-emitting diode.

On a rear face, the optical waveguide 16 has prisms 21 to 26 for representing punctiform light sources or light spots. The prisms are spaced apart from one another in the direction of the arrow 18. By virtue of the prisms, light is reflected in the direction of a front face of the optical waveguide 16 such that the woven material 10 is illuminated in punctiform fashion.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

What is claimed is:

1: An illumination device for a motor vehicle, the illumination device comprising a plurality of punctiform light sources configured to illuminate a woven material.

2: The illumination device as recited in claim 1, wherein the illumination device comprises an optical waveguide for representing the punctiform light sources.

3: The illumination device as recited in claim 2, wherein the optical waveguide for representing the punctiform light sources comprises a prism arrangement.

4: The illumination device as recited in claim 3, wherein the prism arrangement comprises a plurality of spaced-apart prisms.

5: The illumination device as recited in claim 1, wherein the illumination device is integrated in a lamp of a motor vehicle.

6: The illumination device as recited in claim 5, wherein the punctiform light sources in the lamp are configured and arranged relative to the woven material such that a depth effect is achieved in the lamp.

7: The illumination device as recited in claim 1, wherein the woven material has special light-refractive properties.

8: A tail lamp comprising an illumination device including a plurality of punctiform light sources configured to illuminate a woven material.

9: The tail lamp as recited in claim 8, wherein the woven material is spanned inside a frame of the tail lamp.

10: A motor vehicle comprising a tail lamp including an illumination device comprising a plurality of punctiform light sources configured to illuminate a woven material.

11: The motor vehicle as recited in claim 10, wherein the woven material is spanned inside a frame of the tail lamp.
